(19) United States
(12) Patent Application Publication
(10) Pub. No.: US 2005/0240984 A1
(43) Pub. Date: Oct. 27, 2005

(54) Code assist for non-free-form programming

(75) Inventors: George N. Farr, Richmond Hill (CA); David Kenneth McKnight, Newmarket (CA)

Correspondence Address: John D. Flynn;International Business Machines,, Intellectual Property Law, Dept.T81/Bldg. 503, PO Box 12195, Research Triangle Park, NC, 27709, US

(73) Assignee: International Business Machines Corporation, Armonk, NY (US)

(21) Appl. No.: 10/831,034

(22) Filed: Apr. 23, 2004

(51) Int. Cl. H04L 9/00; H04L 9/32; G06F 11/30; G06F 12/14

(52) U.S. Cl. 726/1

(57) ABSTRACT

A code- or content-assist for various programming languages respects the boundaries of the data field in which the data is the be entered. Depending upon whether the data must be aligned within the column, as required by the programming language or by the spreadsheet or database, the content-assist widget and its method inserts or replaces selected completions proffered by the content-assist. In any event, the row and column of the data entry position is determined; the range of the column is compared with the selected completion. If position of data in the column is sensitive, then spaces may be appended, if necessary, to the selected completion to fill the column range. Otherwise or in a free-form programming language, the data entered by the user is removed from the selected completion and the modified selected completion is inserted at the column of data entry. The proposed completions may be filtered, depending upon previous entries, entries of the user, programming languages, types of code lines.

### BACKGROUND OF THE INVENTION

This invention relates generally to computer user interfaces, and more particularly relates to a widget and a method by which column sensitive data can be input into a fixed-form, mixed-form, and/or free-form data field irrespective of programming language.

In the field of graphical user interfaces, a widget called a “content-assist” has been developed to facilitate data entry. When entering alphanumeric, string characters, or other data in an editor, a user may invoke the content-assist that hovers around the data entry field and display a list of possible entries that complete the data. The content-assist may also display optional help information about each possible entry. These entries, called completions, may be used if the completions are in the same programming language of the source being entered or edited. The list of completions may further be filtered so that only completions that match the first portion of what the user has typed are displayed. When a user sees a match that she/he would like to use, she/he selects the completion thereby inserting the selection's text in the field where the user had been typing.

An example of such a widget is set forth in FIG. 1. The content-assist widget 100 typically does not arise in its own window as shown, but may do so; typically only the small window 112 of possible completions is shown along with the data entry field 110. In the figure, a user has entered “ab_” where _ indicates the position of the cursor. The window of possible completions 112 automatically arises and the possibilities for completing the data entry are shown: “AB”, “ABBA”, “ABBAABB”, “ABCDEF”, and “ABCDE35*.” The user has selected the option labeled 114 “ABBAABB”, as indicated by the highlighting, for completion of the data to be entered into the field 110. The application program interface will immediately enter the ABBAABB into the field 110 and the user need not complete entering the data.

There are many programming language editors that provide content-assist. For example, in the Eclipse Integrated Development Environment (IDE), the Java Editor provides content-assist for the Java language wherein completions are based on the current text and scope within Java source where the user types information available via a Java parser. Completions may comprise class names, variable names, field names, method names, etc.; anything that is or could be visible from a compiler's point of view. When a user selects a completion, the text of the completion is inserted in place of the original token of text that was being typed in the editor before content-assist was invoked. If the text length of the completion exceeds that of the original text, all text on the line in the editor after the position where the completion occurs is shifted to the right depending on the length of the completion text. This approach of shifting post-insertion text to the right is typical of the content-assist implementations for modern programming languages.

Programming languages, such as Java, are free-form languages in that the syntax is not column sensitive, i.e., the width of the columns does not determine if the source code in the column is correct or not. Because these languages are not column sensitive, the shifting of text in response to selecting a completion widget does not cause the entry to become invalid. There are, however, other programming languages that are column sensitive, referred to herein as fixed-form languages. The syntax of a fixed-form language depends on certain code being at certain column positions within an editor. An example is the RPG programming language in which each line of code is of a particular type that determines the syntax and semantics of the code; for example, a D-Spec line specifies data types, and a C-Spec lines specifies calculations often using data defined in a D-Spec line. Each type of line has a unique syntax dependent on pieces of source code residing within the bounds of columns.

There are also programming languages that have both fixed-form and free-form syntax, called mixed-form programming languages. The programming language RPG is really mixed-form because it allows both fixed-form and free-form syntax. As indicated above, RPG code needs to reside in certain columns depending on the type of line but there is also a syntax that allows some code to follow free-form, non-column sensitive rules.

### BRIEF SUMMARY OF THE INVENTION

According to one aspect of the present invention, a method for entering data in a computer system comprises capturing the position of a cursor in a data entry field into which to enter data, determining the column of the position of the cursor, capturing the data entered by a user into the entry field, retrieving and displaying possible completions based on the data entered, capturing the completion selected by the user, determining the length of the selected completion, and obtaining a range of the column into which the selected completion will be entered.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is an example of a content-assist widget commonly used in graphical user interfaces.

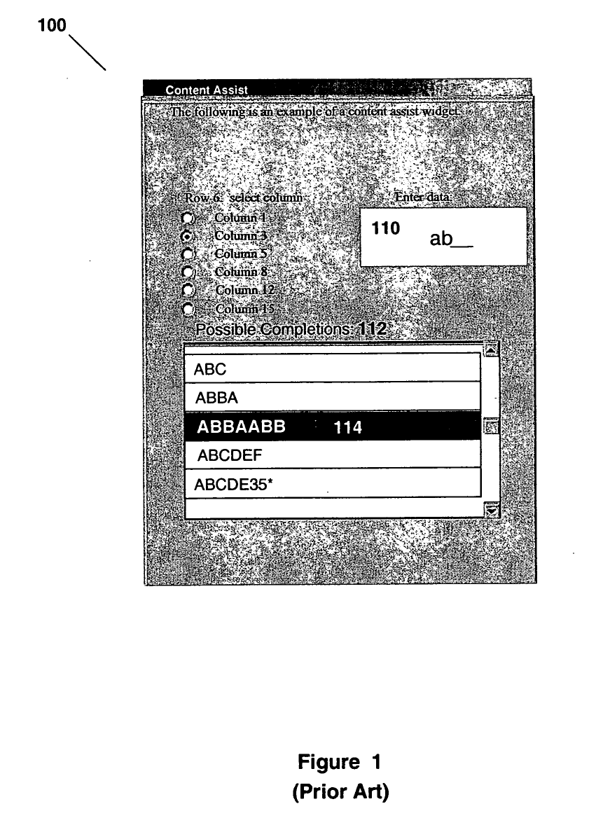

FIG. 2 is a simplified block diagram of a computer network having an object system that may use the content-assist widget with inventive features herein.

FIGS. 3a and 3b are examples of a fixed-form column format and a free-form/mixed-form column format, respectively.

FIG. 4 is a simplified flow chart of a method by which a content-assist widget can enter data into a fixed-form column format in accordance with features of the invention.

FIG. 5 is a simplified flow chart of a method by which a content-assist widget can enter data into a free-form and/or a fixed-form column format in accordance with features of the invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the users computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

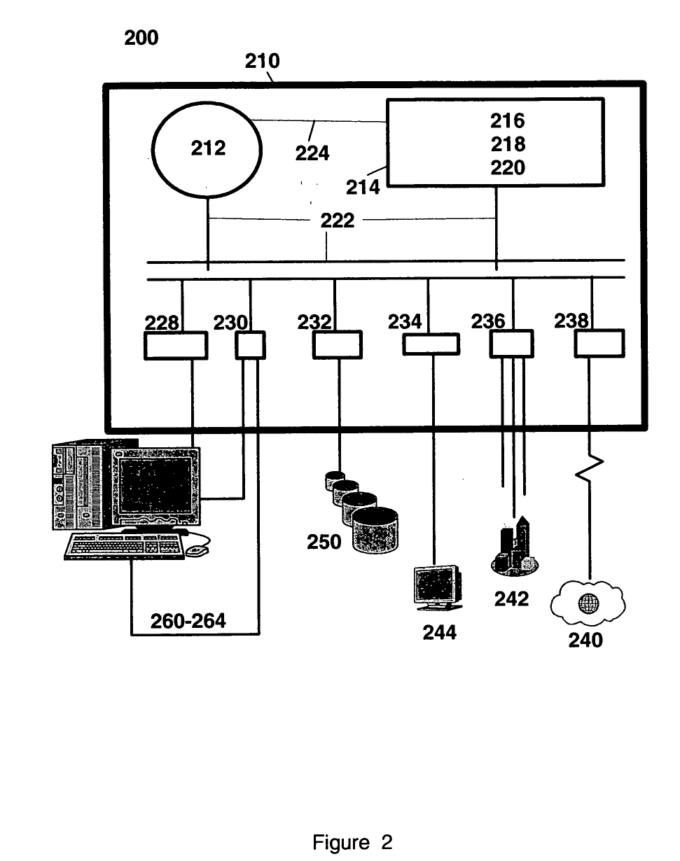

Referring to FIG. 2 a high-level block diagram of a computer network system 200 consistent with an embodiment of the invention is shown. Computer network system 200 may comprise any number of networked computers 210, each of which may have a central processing unit (CPU) 212, main memory 214, and various digital and/or analog interfaces 228-338. The various devices communicate with each other via internal communications bus 222. CPU 212 is a general-purpose programmable processor, executing instructions stored in memory 214; while a single CPU is shown in FIG. 2, it should be understood that computer systems having multiple CPUs could be used. Communications bus 222 supports transfer of data, commands and other information between different devices, and while shown in simplified form as a single bus, it is typically structured as multiple buses including an internal bus 224 which may connect the CPU 212 directly with memory 214.

Memory 214 is a random-access semiconductor memory for storing data and programs; memory 214 is shown conceptually as a single monolithic entity but it is well known that memory is often arranged in a hierarchy of caches and other memory devices, some or all of which may be integrated into the same semiconductor substrate as the CPU 212. Random access memory (RAM) devices comprising the main storage of computer, as well as any supplemental levels of memory, e.g., cache memories, nonvolatile or backup memories, programmable or flash memories, read-only memories, etc. In addition, memory 214 may be considered to include memory storage physically located elsewhere in computer, e.g., a cache memory in a processor or other storage capacity used as a virtual memory, e.g., as stored on a mass storage device or on another computer coupled to computer via network.

Operating system 216 and applications 218, 220 reside in memory 214. Operating system 216 provides, inter alia, functions such as device interfaces, management of memory pages, management of multiple tasks, etc. as is known in the art. Examples of such operating systems may include Linux, Aix, Unix, Windows-based, OS/400, an RTOS, a handheld operating system, etc. On iSeries and AS/400 machines, OS/400 is the native operating system and object system and IFS is the Unix object system complemented by the Qshell Unix command shell. These and other various applications, components, programs, objects, modules, etc. may also execute on one or more processors in another computer coupled to computer 210 via a network 240, 242, e.g., in a distributed or client-server computing environment, whereby the processing required to implement the functions of a computer program may be allocated to multiple computers 210 over a network 240, 242.

The invention is equally applicable to any microprocessor device having an operating system in which the microprocessor or processing device is connected across a network to devices having the same or different operating systems. In general, the routines executed to implement the embodiments of the invention, whether implemented as part of an operating system or a specific application, component, program, object, module or sequence of instructions will be referred to herein as computer programs or simply programs. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Applications 218, 220 may include a content-assist widget as described herein as part of or callable from an integrated development environment, and if a server software application is included, network interface 236, 238 may interact with the server software application to enable computer system 210 to be a network server.

It should be appreciated that computer 210 typically includes suitable analog and/or digital interfaces 228-138 between CPU 212 and the attached components as is known in the art. For instance, computer 210 typically receives a number of inputs and outputs for communicating information externally. For interface with a user or operator, computer 210 typically includes one or more user input devices 260-264, e.g., a keyboard, a mouse, a trackball, a joystick, a touchpad, and/or a microphone, among others, and a display such as a CRT monitor, an LCD display panel, and/or a speaker, among others. It should be appreciated, however, that some implementations of computer 210, e.g., some server implementations, might not support direct user input and output. Terminal interface 234 may support the attachment of single or multiple terminals and may be implemented as one or multiple electronic circuit cards or other units. Data storage 250 preferably comprises one or more rotating magnetic hard disk drive units, although other types of data storage, including a tape or optical driver, could be used. For additional storage, computer 210 may also include one or more mass storage devices 250, e.g., a floppy or other removable disk drive, a hard disk drive, a direct access storage device (DASD), an optical drive e.g., a compact disk (CD) drive, a digital video disk (DVD) drive, etc., and/or a tape drive, among others.

Furthermore, computer 210 may include an interface 236, 238 with one or more networks 240, 242 to permit the communication of information with other computers 210 coupled to the network(s) 240, 242. Network interface(s) 236 238 provides a physical connection for transmission of data to and from a network(s) 240, 242. Network(s) 240, 242 may be the Internet, as well as any smaller self-contained network such as an Intranet, a wide area network (WAN), a local area network (LAN), or other internal or external network using, e.g., telephone transmissions lines, satellites, fiber optics, T1 lines, public cable, etc. and any various available technologies. One of ordinary skill in the art understands that computer system 200 may be connected to more than one network 240, 242 simultaneously. Computer system and remote systems 210 may be desktop or personal computers, workstations, a minicomputer, a midrange computer, a mainframe computer. Any number of computers and other microprocessor devices, such as personal handheld computers, personal digital assistants, wireless telephones, etc., which may not necessarily have full information handling capacity as the large mainframe servers, may also be networked through network(s) 240, 242.

While the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks, e.g., CD-ROMs, DVDs, etc., among others, and transmission type media such as digital and analog communication links. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. The illustrated embodiments are not intended to limit the present invention. Indeed, those skilled in the art will recognize that other alternative hardware and/or software embodiments may be used without departing from the scope of the invention.

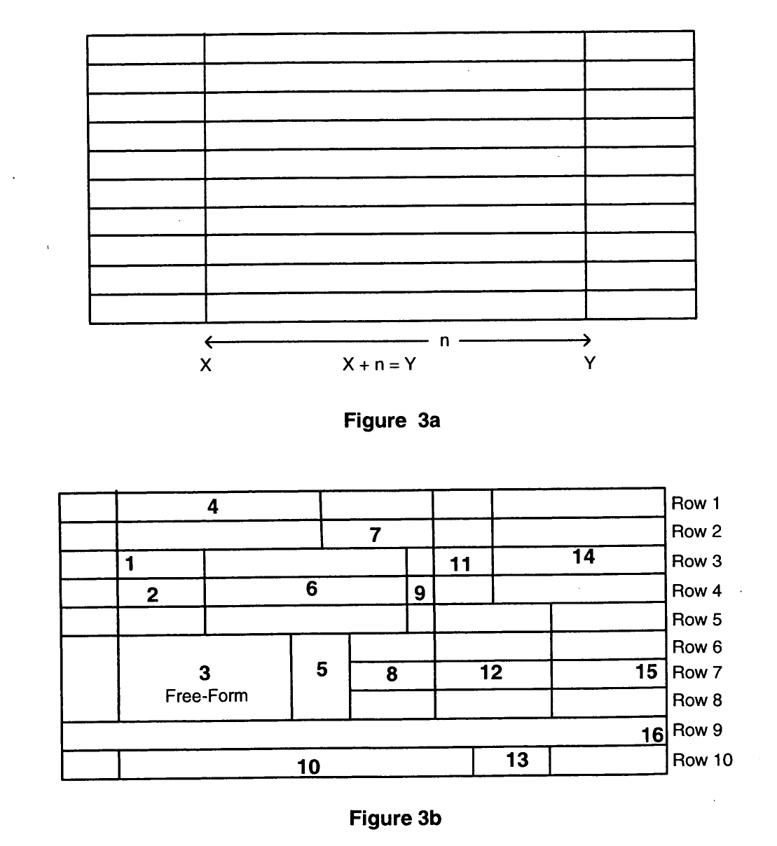

Thus, a computer user may use such a system as described in FIG. 2 when editing or inserting column sensitive data in a non-free-form programming language and anywhere input is required to respect column boundaries, such as certain types of spreadsheets and general forms, herein referred to as a fixed-form column format. Referring now to FIGS. 3a and 3b, a fixed-form column format is shown in FIG. 3a. A hypothetical column-sensitive programming language is presented that illustrates a fixed number of column ranges that are aligned across all rows in the editor. For each column range on each row, there may be a fixed set of possible text values a user can input. In FIG. 3a, column 2 has a starting position of X and an ending position of Y, where both X and Y are positive numbers and Y is greater or equal to X. If Y−X=n, then n is the length of the field or the width of the column in which the completion text will be inserted or replaced.

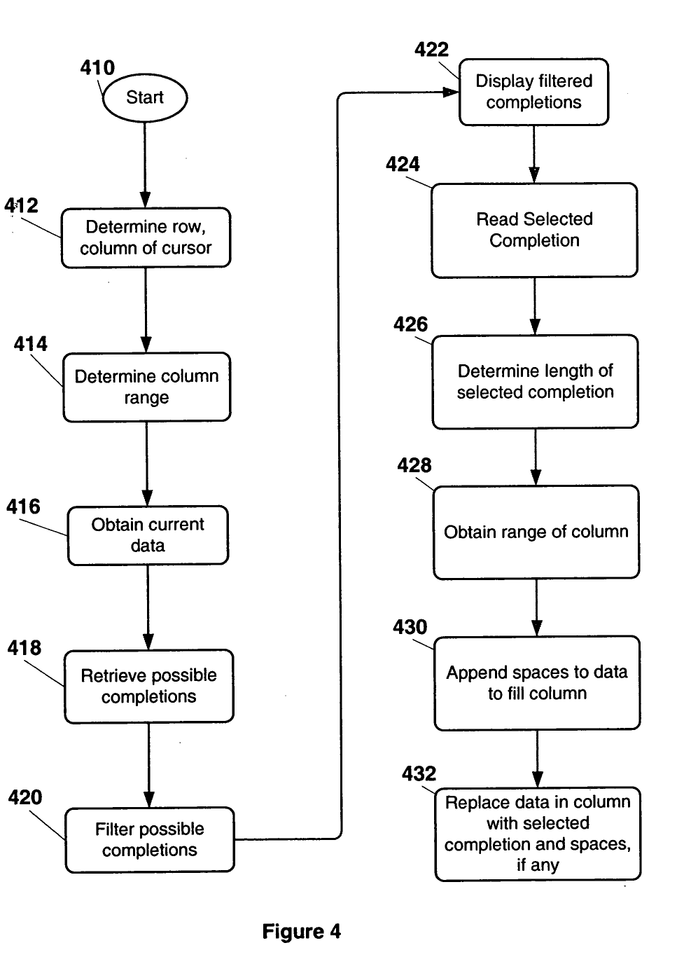

Referring now to FIG. 4, the content-assist widget which is capable of inserting text into a fixed-format column with a non-free form programming language is described herein The process begins at step 410 when the user attempts to use the content-assist code-completion between columns X and Y. In step 412, the content-assist widget according to features described herein first determine the row and column in which the cursor is positioned, i.e., the field in which the user wishes to enter data. Once the column of the cursor position is realized, the range of that column is determined as in step 414. In FIG. 3, the column range X<->Y is n. The method then proceeds to step 416 to obtain the current data which is herein as the data ending with the cursor column and starting at either the first deliminator character, such as a whitespace, or the first character in the column range, whichever is closer to the column in which the cursor is positioned. In step 418, using a programming language database or other means known to one of skill in the art and given the column range, the content-assist widget determine the possible completions for the particular row.

Then in step 420, the possible completions may optionally be filtered based on the current text to obtain and, in step 422, the filtered proposed list of completions are displayed. At step 424, the method reads the user input as she/he selects one of the displayed completions and, in step 426, the process then determines the length of the data to be entered. In step 428, the range of the column in which the data is to be inserted is determined, assuming that n is greater than or equal to the completion data length. In step 430, a number of spaces, D, where D is n minus the length of the current data length, are appended to the proposed data entry to fill the fixed-format column. At step 432, the data in the current column is replaced with the new proposed data. In one aspect of the present invention, the proposed data is replaced rather than inserted.

The following examples further illustrate the method disclosed. Presume a simple column-oriented language that has three fixed-format column ranges per row, as shown in FIG. 3a. For each of the column range on each row, suppose the possible values are the following:

Column 0<->1
ABC
DEFGHI
JKLMNOPQR
Column 2<->2
   123
   456789
   123456
Column 2<->3
   XYZ
   TUVW

### EXAMPLE 1

In this example and the following examples, the numbers above the columns denote column ranges and ‘_’ denotes the cursor position. A user activates content-assist at the location of the cursor “_” and the proposed completions “123” and “123456” arise. The user selects “123456”.

The initial state of an editor is:

| 0 | 1 | 2 | 3 |
|---|---|---|---|
| JKLMNOPQR | 123 | XYZ | |
| ABC | 12_{——} | TUVW | |

In the prior art, using free-form programming language in a fixed-format column, the result would be:

| 0 | 1 | 2 | 3 |
|---|---|---|---|
| JKLMNOPQR | 123 | XYZ | |
| ABC | 123456 | TUVW | |

Using the method of FIG. 4 as described herein, the correct result of the display is:

| 0 | 1 | 2 | 3 |
|---|---|---|---|
| JKLMNOPQR | 123 | XYZ | |
| ABC | 123456 | TUVW | |

### EXAMPLE 2

The user activates content-assist as described herein. The current text is “ ”, so all proposed completions, given the nature of data in the column, are valid, resulting in the proposals “123”, “456789” and “123456”. The user selects “123456”.

The initial state of an editor is:

| 0 | 1 | 2 | 3 |
|---|---|---|---|
| JKLMNOPQR | 123 | XYZ | |
| ABC | _{——} | TUVW | |

Using a prior art free-form programming language in a fixed-format column format, the result would be:

| 0 | 1 | 2 | 3 |
|---|---|---|---|
| JKLMNOPQR | 123 | XYZ | |
| ABC | 123456 | TUVW | |

In accordance with one of the methods described herein, the same result as Example 1 is achieved.

| 0 | 1 | 2 | 3 |
|---|---|---|---|
| JKLMNOPQR | 123 | XYZ | |
| ABC | 123456 | TUVW | |

In general, in a column oriented programming language or form, syntax is determined by the combination of text and associated column boundaries. In addition, the method and widget provided herein is sensitive to whether the completion mode is a “replacement” mode to replace the information in the column with the selected information, or an “insertion” mode that inserts or appends the completion to the data already in the column. In the examples above, selected completion text replaces the data, if any exist, in the column by replacing the text from position X to Y starting at position X. If the length of the completion value is less that X+n, then trailing blanks or whitespaces are appended to fill the column to Y. The above example illustrates a general form where all lines are fixed form and are of the same type.

Many situations, however, involve a fixed-format column and/or a programming language having mixed types such that not all rows having the same column boundaries as before. Considering FIG. 3b, which illustrates a table having ten rows and sixteen different columns. The content-assist widget contemplated by the inventors herein allows data entry with mixed-form programming because the widget and method described not only respects column boundaries and decides whether to insert or replace the data into the column, but adds a requirement to check the type of the line of code. Recall that certain languages, such as RPG programming language, specifies syntactic and semantic requirements based on the source code residing within the column boundaries; for example, a D-Spec line specifies data types, a C-Spec line of code specifies calculations that may use the data of a D-Spec line.

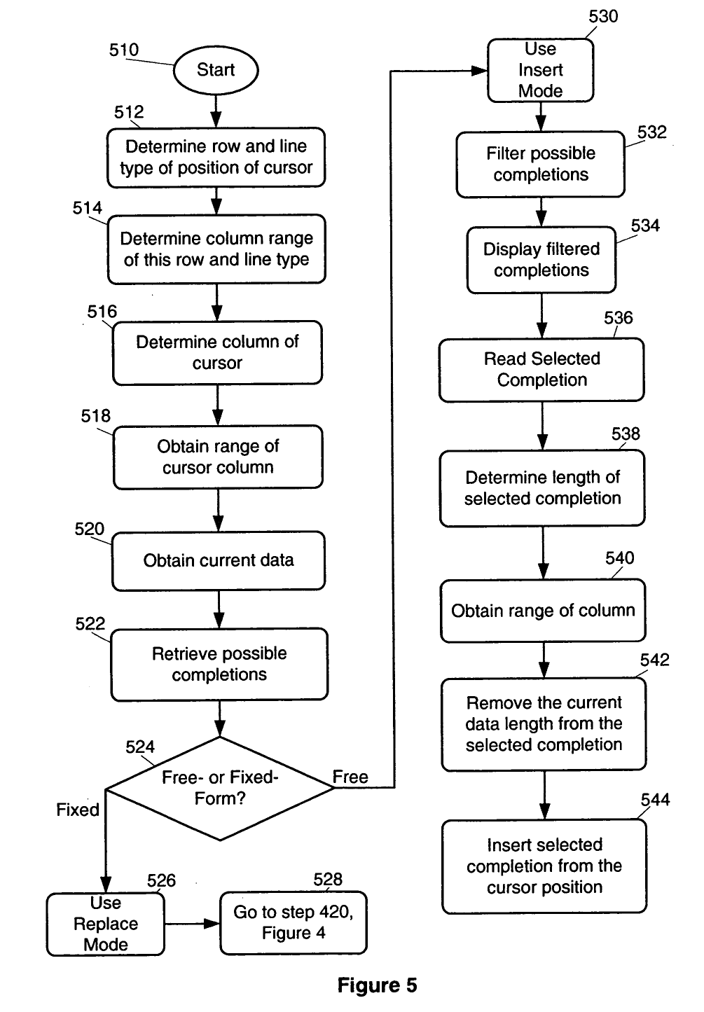

The algorithm by which the content-assist widget completes data entry for mixed line types and free-format columns is shown in FIG. 5. Upon invocation of the code-completion widget, step 510, the content-assist widget ascertains the location of the cursor row and the type of line. Then in step 514, based on the row and line type, the process determines the column boundaries or the range of the column. In step 516, the particular column of the cursor is resolved and the range of the column is determined in step 518. In step 520, the current data ending is obtained; the current data is that at the cursor column and starting at either the first delimiter character, e.g., a whitespace, or the first character in the column range, whichever is closer to the position of the cursor. From an object database or from the programming language database, the possible completions for this column range are retrieved in step 522. The process then determines in step 524 whether the column format for this row is a fixed-form column or a free-form column. If the column boundaries are fixed-form, then in step 526, the mode becomes “replacement” in which the proposed completions replace the current text, so the process undergoes the same steps starting at block 420 in FIG. 4.

If the column is a free-format column, then the mode become an “insert” mode, as in step 530 and proposed completions will be inserted into the data in the column. In step 532, the proposed completions are filtered, and the filtered completions are displayed in step 534. When the user selects one of the displayed completions as in step 536, the “insert” mode then determines the length of the selected completion in step 538 and obtains the range of the column in which the data will be inserted, as in step 540. In step 542, the length of the data that is already in the free-form field is removed from the selected completion. Then in step 544, the selected completion is inserted from the cursor position.

This invention may be used in an integrated development environment, such as Eclipse, but is not intended to be limited to either any particular application or programming language. Any user interface of any business, scientific, statistical, system management, and/or database application in which an editor may be used to modify or insert column sensitive data, such as spreadsheets and general forms are able to incorporate the column-sensitive content-assist widget described herein. The present invention has been described for use in a graphical user interface using typed data entered at a cursor but one of ordinary skill in the art will understand that the invention is not intended to be so limited. Input may be provided by voice or other user interfaces known. Thus, the phrase “cursor” is construed to include the point at which data is to be entered.

While various embodiments of the present invention have been described above, it should be understood that they have been presented by way of example and not limitation and that variations are possible. Thus, the breadth and scope of the present invention should not be limited by any of the above-described exemplary embodiments, but should be defined only in accordance with the following claims and their equivalents.

1. A method for entering data in a computer system, the method comprising:
capturing the position of a cursor in a data entry field into which to enter data;
determining the row and the column of the position of the cursor;
capturing the data entered by a user into the entry field;
retrieving and displaying possible completions based on the data entered;
capturing the completion selected by the user;
determining the length of the selected completion; and
obtaining a range of the column into which the selected completion will be entered.

2. The method of claim 1, further comprising replacing the data entered by a user into the entry field with the selected completion.

3. The method of claim 2, further comprising appending spaces to the selected completion to fill the range of the column, and replacing the data entered by a user into the entry field with the selected completion and the appended spaces.

4. The method of claim 1, further comprising filtering the possible completions and displaying the filtered completions.

5. The method of claim 4, wherein filtering the possible completions is determined by the data entered by the user.

6. The method of claim 4, wherein filtering the possible completions is determined by the programming language.

7. The method of claim 1, further comprising determining the line type of data to be entered into the data entry field.

8. The method of claim 7, further comprising filtering the possible completions and displaying the filtered completions and wherein filtering the possible completions is determined by the line type of data to be entered into the data entry field.

9. The method of claim 7, wherein determining the line type of data to be entered into the data entry field is executed in a free-form programming language.

10. The method of claim 9, further comprising:
removing the data length entered by a user into the entry field from the selected completion; and
inserting the selected completion from the position of the cursor.

11. A method for entering data in a computer system, the method comprising:
receiving input of a cursor position where data is to be entered;
determining the range of the column in which the cursor is positioned;
obtaining data that may be and/or has been entered by a user;
retrieving and displaying possible completions of the data to be entered;
receiving input from the user of the selected completion;
determining the length of the selected completion; and
obtaining a range of the column in which the data is to be entered.

12. The method of claim 11 further comprising determining that the data to be entered is a fixed-form programming language.

13. The method of claim 12 wherein the data to be entered is a particular line type and further comprising deriving the syntax and semantics of the data from the position of the data in the column.

14. The method of claim 13 further comprising appending spaces to the selected completion to align the data in the column for meaningful syntax and semantics.

15. The method of claim 14 further comprising replacing the data in the data entry field with the selected completion and the appended spaces.

16. The method of claim 11 further comprising:
determining that the data to be entered is not a fixed-form programming language;
removing from the selected completion the data entered by the user into the data entry field; and
inserting the modified selected completion into the data entry field.

17. A computer program product for entering data into a computer system, the computer program product comprising:
a computer readable medium having computer readable program code embodied therein, the computer readable program code comprising:
computer readable program code configured to capture the position of a cursor in a data entry field into which to enter data;
computer readable program code configured to determine the row and the column of the position of the cursor;
computer readable program code configured to capture the data entered by a user into the entry field;
computer readable program code configured to retrieve and display possible completions based on the data entered;
computer readable program code configured to capture the completion selected by the user;
computer readable program code configured to determine the length of the selected completion; and
computer readable program code configured to obtain a range of the column into which the selected completion will be entered.

18. The computer program product of claim 17 further comprising computer readable program code configured to replace the data entered by a user into the entry field with the selected completion.

19. The computer program product of claim 17 further comprising computer readable program code configured to filter the possible completion and display the filtered completions.

20. The computer program product of claim 17 further comprising computer readable program code configured to determine the type of data to be entered into the data entry field.

21. A computer program product for transmission of a column-sensitive content-assist widget to be implemented on a processing device, the computer program product comprising:
a computer readable medium having computer readable program code embodied therein, the computer readable program code comprising:
computer readable program code configured to receive input of a cursor position where data is to be entered in a computer object system;
computer readable program code configured to determine the range of the column in which the cursor is positioned;
computer readable program code configured to obtain data that may be and/or has been entered by a user;
computer readable program code configured to retrieve and display possible completions of the data to be entered;
computer readable program code configured to receive input from the user of the selected completion;
computer readable program code configured to determine the length of the selected completion; and
computer readable program code configured to obtain a range of the column in which the data is to be entered.

22. The computer program product of claim 21 further comprising computer readable program code configured to determine that the data to be entered is a fixed-form programming language.

23. The computer program product of claim 22 wherein the data to be entered is a particular line type and further comprising computer readable program code configured to derive syntax and semantics of the data from the position of the data in the column.

24. The computer program product of claim 23 further comprising computer readable program code configured to append spaces to the selected completion to align the data in the column for meaningful syntax and semantics.

25. The computer program product of claim 24 further comprising computer readable program code configured to replace the data in the data entry field with the selected completion and the appended spaces.

26. The computer program product of claim 21 further comprising computer readable program code configured to determine that the data to be entered is not a fixed-form programming language, computer readable program code configured to remove the data entered by the user into the data entry field from the selected completion, and computer readable program code configured to insert the modified selected completion into the data entry field.

27. A code-assist widget for use in a computer system executing applications having both fixed-format and free-format data entry fields, comprising:
a determinator of whether a data entry field is a fixed-format data entry field or a free-format data entry field;
a replacement mode wherein a first completion proposed by the code-assist widget is appended with at least one space if necessary to fill the fixed-format data entry field, and any data entered in the fixed-form data entry field is replaced by the first completion and any appended spaces; and
an insertion mode wherein data entered in the free-form data entry field is removed from a second completion proposed by the code-assist widget and the modified second completion is inserted at a cursor position in the free-form data entry field.

28. A column-sensitive content-assist for use inputting data into a computer system, comprising:
means for positioning a cursor for data entry in a data entry field;
means for determining the row and the column of the cursor position;
means for determining the size of the field in which the data is to be entered;
means for determining if a programming language used to enter data is a fixed-form programming language;
means for retrieving and informing the user of possible completions for data entry into the data entry field; and
means for retrieving the selected completion of the user.

29. The column-sensitive content-assist of claim 28, further comprising means for appending spaces, if necessary, to the selected completion when in a fixed-form programming language and means for replacing the data in the data entry field with the selected completion and means for appending spaces to fill the size of the data entry field.

30. The column-sensitive content-assist of claim 28, further comprising means for removing data entered by the user from the selected completion and then to insert the modified selected completion at the cursor position.
